(19) United States
(12) Patent Application Publication
(10) Pub. No.: US 2009/0125152 A1
(43) Pub. Date: May 14, 2009

(54) METHOD OF MEASUREMENT, CONTROL, AND REGULATION FOR THE SOLAR THERMAL HYBRIDIZATION OF A FOSSIL FIRED RANKINE CYCLE

(75) Inventors: Mark Joseph Skowronski, Irvine, CA (US); Ronald Farris Kincaid, Los Alamitos, CA (US)

Correspondence Address: KNOBBE MARTENS OLSON & BEAR LLP, 2040 MAIN STREET, FOURTEENTH FLOOR, IRVINE, CA, 92614, US

(73) Assignee: Markron Technologies, LLC, Los Alamitos, CA (US)

(21) Appl. No.: 12/267,485

(22) Filed: Nov. 7, 2008

Related U.S. Application Data
(60) Provisional application No. 61/002,447, filed on Nov. 9, 2007.

(51) Int. Cl. B60K 16/00; F01K 7/16; G05D 9/12; G06F 1/28

(52) U.S. Cl. 700/281; 60/670; 60/659; 60/641.8; 700/289

(57) ABSTRACT

A method of measurement, control, and regulation for a solar integrated Rankine cycle power generation system can include a central processing unit (CPU) which receives input from an operator and/or sensors regarding load forecast, weather forecast, system cost, and capacity or efficiency needs. The method can include activation, in various sequencing, of heat transfer fluid control valves, storage control valves, and at least one turbine control valve.

### CROSS-REFERENCE TO RELATED APPLICATIONS

This application claims priority to U.S. Provisional Patent Application No. 61/002,447, entitled “METHOD OF MEASUREMENT, CONTROL, AND REGULATION FOR THE SOLAR THERMAL HYBRIDIZATION OF A FOSSIL FIRED RANKINE CYCLE” filed on Nov. 9, 2007, which is incorporated herein by reference in its entirety.

### BACKGROUND OF THE INVENTIONS

1. Field of the Inventions

The application relates generally to methods for control and regulation of power generation, and more specifically to methods for control and regulation of power generation systems which integrate a regenerative Rankine cycle power generation system with a solar energy collection system to achieve enhanced power generation efficiency.

2. Description of the Related Art

Rankine cycle power generation systems generate power by alternately vaporizing and condensing feedwater. In a typical Rankine cycle power plant, the feedwater is vaporized in a boiler to which heat energy is added such as by the combustion of a fossil fuel (e.g. coal). The vapor is then expanded through a turbine to generate power output. Many fossil fueled Rankine cycle power generation systems use both reheat and regeneration in an attempt to raise the cycle efficiency. Reheat comprises the returning of steam, which has been partially expanded in the turbine, back to the boiler for additional heating prior to continued expansion in the turbine. Regeneration is a method to limit condenser loss in a Rankine cycle by taking partially expanded steam (extracted from the steam turbine) and using it to pre-heat the feedwater prior to heating and vaporization in the boiler.

Attempts have been made to reduce reliance on sources of fossil fuel by integrating collection of solar energy into a power generation system. For example, in a solar Rankine power generation system, a solar boiler can use solar energy to vaporize feedwater, which can be expanded through a turbine and condensed to begin the cycle anew. Such solar thermal generation facilities are relatively expensive, require the use of a fairly complex solar boiler, and are relatively inefficient due to the lower operating temperature of the working fluid compared to fossil fired cycles. Thus, solar Rankine power generation systems cannot compete, in most cases, with traditional fossil fuel generated electrical energy. Additionally, solar Rankine power generation systems cannot operate (without fossil-fuel back up or storage) during severe overcast or night hours.

Attempts have been made to integrate solar power generation with a fossil-fuel power generation system by, for example, using solar energy to heat a portion of the feedwater (i.e. feedwater) in a Rankine cycle. However, in these attempts, the solar thermal heat is used to produce steam for feedwater heating, or the steam is integrated into the heat transfer systems of the boiler, or the solar thermal cycle has its own separate Rankine cycle that is integrated into the coal Rankine cycle. While these methods provide some additional heat to the Rankine cycle, all have certain restrictions and cost disadvantages.

One of the latest and most cost effective methods proposed for integrating solar heat into a Rankine cycle uses a single phase fluid that is directly heated by the sun, and pre-heats feedwater going into the boiler. Such a method is described in U.S. patent application Ser. No. 11/894,033, entitled “METHOD AND SYSTEM INTEGRATING SOLAR HEAT INTO A REGENERATIVE RANKINE CYCLE,” filed Aug. 17, 2007, which is incorporated herein by reference in its entirety.

### SUMMARY OF THE INVENTIONS

An aspect of at least one of the embodiments disclosed herein includes the realization that it would be advantageous to operate power generation systems which integrate solar heating differently under different conditions in order to meet specific power generation needs. The solar heating capabilities and output of a Rankine cycle power generation system can vary depending on, for example, the load forecast received from a grid regulating entity, weather forecasts (e.g. the amount of sunlight available on a given day), the expected costs of power generation, and the amount, if any, of any solar energy which has already been stored in a solar storage unit. It can often be desirable to run such power generation systems under maximum capacity, maximum efficiency, or a combination of both. Thus, there is a need for an operator control system, as well as operator controls and routines, which allow an operator to run the solar integrated system in different modes under different conditions to help ensure system stability and operation within the Rankine unit's limits.

Thus, in accordance with an embodiment, a control system for use in a Rankine cycle power plant that integrates solar heating can comprise an operator interface, a central processing unit in communication with the operator interface, at least one heat transfer fluid control valve in communication with the central processing unit and configured to be activated by the central processing unit in response to operator input, at least one storage control valve in communication with the central processing unit and configured to be activated by the central processing unit in response to operator input, and at least one turbine control valve in communication with the central processing unit and configured to be activated by the central processing unit in response to operator input. The central processing unit can be configured to receive operating parameter input from an operator. The central processing unit can also be configured to receive inputs from sensors which measure the temperature, flow rate, and pressure of heat transfer fluid supplying solar thermal energy to the Rankine cycle plant.

Thus, in accordance with an embodiment, a control method for maximizing capacity in a Rankine cycle power generation system that integrates solar heating can comprise operating a series of heat transfer fluid control valves, storage control valves, and turbine control valves which are located throughout the system, determining and inputting the Rankine cycle power generation system's needs and limits of unit restraints and impacts into a central processing unit, the central processing unit configured to determine whether the system is configured for solar heat storage, and based on the storage determination, sequentially open a storage control valve and heat transfer fluid control valve if storage is used, or open a direct line heat transfer fluid control valve if no storage is used, and open a heat transfer fluid control valve in fluid communication with a first solar feedwater heater located upstream of a high pressure feedwater heater in the Rankine cycle, and measure heat transfer fluid temperature, flow rate, and pressure to and from the first solar feedwater heater, and determine whether the first solar feedwater heater has reached a maximum solar heat input level, and when the first solar feedwater heater has reached the maximum solar heat input level, open a heat transfer fluid control valve in fluid communication with a second heat transfer fluid control valve located downstream of the high pressure feedwater.

In accordance with another embodiment, a control method for maximizing efficiency in a Rankine cycle power generation system that integrates solar heating can comprise operating a series of heat transfer fluid control valves, storage control valves, and turbine control valves which are located throughout the system, determining and inputting the Rankine cycle power generation system's needs and limits of unit restraints and impacts into a central processing unit, the central processing unit configured to determine whether the system is configured for solar heat storage, and based on the storage determination, sequentially open a storage control valve and heat transfer fluid control valve if storage is used, or open a direct line heat transfer fluid control valve if no storage is used, and open a heat transfer fluid control valve in fluid communication with a first solar feedwater heater located downstream of a high pressure feedwater heater in the Rankine cycle, and measure heat transfer fluid temperature, flow rate, and pressure to and from the first solar feedwater heater, and determine whether the first solar feedwater heater has reached a maximum solar heat input level, and when the first solar feedwater heater has reached the maximum solar heat input level, open a heat transfer fluid control valve in fluid communication with a second heat transfer fluid control valve located upstream of the high pressure feedwater.

Another aspect of at least one of the embodiments disclosed herein includes the realization that controlling an amount of turbine capacity usage and efficiency in a solar integrated Rankine cycle power generation system that uses solar collectors can be accomplished by regulating heat transfer fluid control valves, regulating an amount of heat transfer fluid delivered to a solar feedwater heater or heaters from the solar collectors, regulating the temperature to a boiler in the system, and regulating turbine control valves.

Thus, in accordance with an embodiment, a method of operating a fossil fuel Rankine cycle power plant that integrates solar heating can comprise heating a volume of feedwater into steam with a fossil fuel fired boiler, directing the steam to a turbine, the turbine being operatively coupled to a generator, reheating the steam by returning at least a portion of the steam back to the fossil fuel fired burner from the turbine, directing steam from an exit of the turbine to a condenser, wherein the steam is condensed back into feedwater, directing the feedwater from the condenser through a feedwater heater train, the feedwater heater train comprising a plurality of feedwater heaters, directing a portion of the steam in the turbine through steam extraction lines to the feedwater heater train, wherein the portion of steam directed through the steam extraction lines is used to heat the feedwater moving through the feedwater train, directing the heated feedwater from the feedwater train back to the fossil fuel fired boiler, heating a single phase heat transfer fluid with solar heat collectors, directing at least a portion of the heated heat transfer fluid from the solar heat collectors to at least one solar feedwater heater, the at least one solar feedwater heater being fluidly coupled in series with the plurality of feedwater heaters in the feedwater heater train, heating the feedwater moving through the at least one solar feedwater heater with the heated heat transfer fluid, returning the heat transfer fluid back to the solar heat collectors in a closed loop after it has passed through the at least one solar feedwater heater in order to reheat the heat transfer fluid with the solar collectors, and controlling an amount of turbine capacity usage and efficiency of the cycle by regulating heat transfer fluid control valves, regulating an amount of heat transfer fluid delivered to the at least one solar feedwater heater, regulating the temperature to the boiler, and regulating turbine control valves.

Another aspect of at least one of the embodiments disclosed herein includes the realization that it can be desirable to have methods to know how much heat is being transferred to a solar feedwater heater in a solar integrated Rankine cycle power generation system. This can be accomplished by measuring the temperature, pressure, and flow rate of the heat transfer fluid both before it enters the solar feedwater heater and after it exits the solar feedwater heater. It can also then be desirable to adjust the flow rate of the heat transfer fluid moving through the solar feedwater heater or heaters by regulating heat transfer fluid control valves and, consequently, a turbine control valve or valves to adjust steam flow in the turbine.

Thus, in accordance with an embodiment, a method of controlling turbine capacity usage and fossil fuel consumption in a Rankine cycle power plant that integrates solar heating can comprise heating heat transfer fluid with solar heat collectors, delivering the heated heat transfer fluid from the solar heat collectors to at least one solar feedwater heater coupled to a feedwater train, heating feedwater in the solar feedwater heater with the heated heat transfer fluid, calculating the heat delivery to the solar feedwater heater by measuring the temperature, pressure, and flow rate of the heat transfer fluid both before it enters the solar feedwater heater and after it exits the solar feedwater heater, and using known physical properties of the heat transfer fluid, adjusting the flow rate of the heat transfer fluid moving through the at least one solar feedwater heater by regulating heat transfer fluid control valves located between the solar collectors and the at least one solar feedwater heater, and regulating at least one turbine control valve located in a high pressure steam line, the at least one turbine control valve controlling the amount of steam allowed to move through the high pressure turbine. The amount of turbine capacity usage and fossil fuel consumption can be adjusted by both the regulation of the heat transfer fluid control valves and the at least one turbine control valve.

Another aspect of at least one of the embodiments disclosed herein includes the realization that solar integrated Rankine cycle power generation systems can include heat storage. It is desirable to have methods for controlling the storage of solar heat in such systems.

Thus, in accordance with an embodiment, a method for solar heat storage in a Rankine cycle power plant that integrates solar heating can comprise heating a single phase heat transfer fluid with solar heat collectors, delivering the heated heat transfer fluid from the solar heat collectors to at least one solar feedwater heater coupled to a feedwater train, heating feedwater in the at least one solar feedwater heater with the heated heat transfer fluid, and calculating the current heat delivery to the solar feedwater heater by measuring the temperature, pressure, and flow rate of the heat transfer fluid both before it enters the at least one solar feedwater heater and after it exits the at least one solar feedwater heater, and using known physical properties of the heat transfer fluid. The method can further comprise determining the amount of future heat delivery available from the solar heat collectors based on forecasted conditions, comparing the amount of future heat delivery available with both the current calculated heat delivery and projected future heat delivery needs of the plant, regulating a first storage control valve located between the solar heat collectors and a storage tank to control an amount of heated heat transfer fluid entering the storage tank from the solar heat collectors, the storage tank operatively coupled to both the solar heat collectors and the at least one solar feedwater heater, based on the current and projected heat delivery needs of the plant, and regulating a second storage control valve located along a bypass line between the solar heat collectors and the solar feedwater heater to control an amount of heated heat transfer fluid moving directly from the solar heat collectors to at least one of the at least one solar feedwater heater, based on the current and projected heat delivery needs of the plant.

Another aspect of at least one of the embodiments disclosed herein includes the realization that certain benefits can result from placing a solar feedwater heater upstream of a high pressure heater, and another solar feedwater heater downstream of a high pressure heater in a solar integrated Rankine cycle power generation system, and that regulating heat transfer fluid control valves, storage control valves, and at least one turbine control valve can control the capacity and efficiency of the system.

Thus, in accordance with an embodiment, a method for controlling turbine capacity usage and efficiency in a Rankine cycle power plant integrating solar heating can comprise heating a heat transfer fluid with solar heat collectors, the solar heat collectors operatively coupled to a feedwater train, positioning a first solar feedwater heater downstream of a high pressure feedwater heater in the feedwater train such that feedwater leaves the first solar feedwater heater and enters a fossil fuel burner, and positioning a second solar feedwater heater upstream of the high pressure feedwater heater. The method can further comprise measuring the temperature of feedwater leaving the first solar feedwater heater, and calculating the efficiency gain of the power plant due to the feedwater being heated by the first solar feedwater heater before entering the fossil fuel burner, the efficiency gain determined by the impact of solar heat addition to the Rankine cycle, based on the measured temperature. The method can further comprise calculating the value of capacity usage for a turbine, the turbine operatively connected downstream of the fossil fuel burner, the turbine capacity gain determined by measuring the amount steam being sent through steam extraction lines connecting the turbine to the feedwater train, calculating the projected amount of heat required in order to optimize the efficiency gain and capacity usage, and regulating heat transfer fluid control valves located between the solar heat collectors and the solar feedwater heaters, storage control valves located between the solar heat collectors and a heat storage tank, and at least one turbine control valve located along the steam extraction line, based on the calculation of the projected amount of heat required.

### BRIEF DESCRIPTION OF THE DRAWINGS

These and other features and advantages of the present embodiments will become more apparent upon reading the following detailed description and with reference to the accompanying drawings of the embodiments, in which:

FIG. 1 is a schematic diagram of one embodiment of a Rankine cycle power generation system having a solar heat system integrated in a regeneration cycle;

FIG. 2 is a schematic diagram of another embodiment of Rankine cycle power generation system having a solar heat system integrated into a regeneration cycle;

FIG. 3 is a schematic diagram of another embodiment of Rankine cycle power generation system having a solar heat system integrated into a regeneration cycle;

FIGS. 4A and 4B are schematic diagrams of storage systems for use with the embodiments of FIGS. 1-3;

FIG. 5 is a schematic diagram of various configurations for an embodiment of a solar feedwater heater;

FIG. 6 is a schematic diagram of another embodiment of Rankine cycle power generation system having a solar heat system integrated into a regeneration cycle;

FIG. 7 is a schematic diagram of another embodiment of Rankine cycle power generation system having a solar heat system integrated into a regeneration cycle;

FIG. 8 is a schematic diagram of an optimizing calculator, regulator, and controller;

FIG. 9 is a schematic diagram of a solar heat calculator;

FIG. 10 is schematic diagram of a Rankine cycle power generation system and control system parameters;

FIG. 11 is a schematic diagram of a control system for use with Rankine cycle power generation system that integrates solar heat;

FIG. 12 is a schematic diagram of a control routine for maximizing capacity in a Rankine cycle power generation system that integrates solar heat; and

FIG. 13 is a schematic diagram of a control routine for maximizing efficiency in a Rankine cycle power generation system that integrates solar heat.

### DETAILED DESCRIPTION OF THE PREFERRED EMBODIMENT

The embodiments disclosed herein are described in the context of a coal-fueled Rankine cycle power generation system using regenerative heating because the embodiments disclosed herein have particular utility in this context. However, the embodiments of the methods and control routines described herein can also be applied to other types of power generation systems, including but not limited to natural gas or nuclear fueled boiler power generation systems and other regenerative steam Rankine cycle power generation systems.

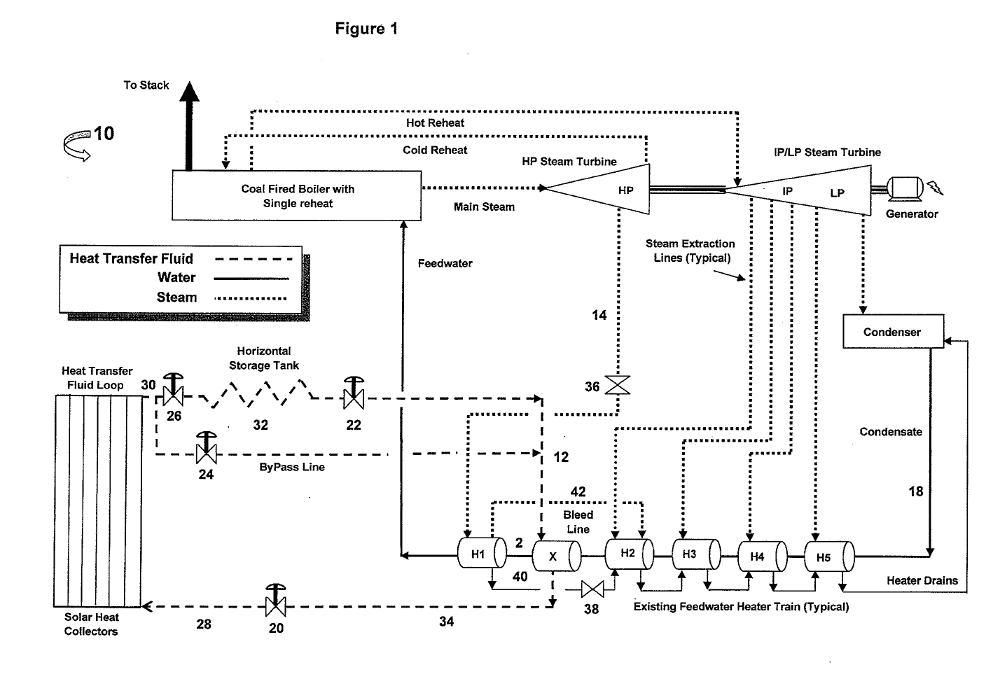

In general, and with reference to FIGS. 1-3, a Rankine cycle power generation system can generate power through the vaporization and condensation of a working fluid (e.g. feedwater) in a heat cycle. Vaporization of the feedwater is accomplished in a boiler, with energy provided by the combustion of a fossil fuel, such as by the burning of coal. The feedwater can be water, which, upon the addition of sufficient heat energy, can vaporize into water steam. A main steam line can fluidly couple the boiler to a turbine over which the vaporized feedwater is expanded, thus driving the turbine.

Some large coal plants use both reheat and regeneration to achieve high cycle efficiency. Reheat, as illustrated in FIGS. 1-3, is defined as the returning of steam, which has been partially expanded in the turbine, back to the boiler for an additional heating prior to continued expansion in the turbine. Regeneration, as also illustrated in FIGS. 1-3, is a method to limit condenser loss in a Rankine cycle by taking partially expanded steam (extracted from the steam turbine) and using it to pre-heat the feedwater prior to heating and vaporization in the boiler. By pre-heating the feedwater, less heat energy is needed in the boiler to produce steam and, since the partially expanded steam is condensed using feedwater as the “heat sink,” less heat is rejected to the condenser.

Regeneration can be accomplished using either “open” or “closed” feedwater heaters. In the “open” heater, the extracted steam from the turbine is mixed directly with the feedwater. In the “closed” feedwater heater, the extraction steam is not mixed directly with the feedwater, but both sensible and latent heat transfer is achieved to boost the feedwater temperature.

With continued reference to FIGS. 1-3, solar heat energy can be used to supplement power generation by large utility-sized power plants which are used to generate electricity. Such solar supplementation can provide great benefit to both new and existing power generation plants, reducing the operating costs involved with energy production. Numerous coal plants, particularly those located in the southwestern United States, are located in isolated areas that have high solar insolation, and are prime candidates for solar thermal retrofit.

FIGS. 1-3 illustrate three different methods for integration of solar heat energy provided by a single phase heat transfer fluid into the feedwater of a Rankine cycle. With reference to FIG. 1, a solar feedwater heater X can be placed immediately upstream of a high pressure heater H1. A thermal heat transfer fluid can be heated by the solar heat collectors and circulated in a transfer fluid line to the solar feedwater heater. A common single phase thermal heat transfer fluid can be used in a heat transfer process to both collect the solar heat energy and to add heat into the feedwater stream of the coal plant, thus supplanting a portion of the turbine extraction steam used to pre-heat the feedwater. The thermal heat transfer fluid can be selected to have desirable thermodynamic properties. For example, the thermal heat transfer fluid can be selected to remain in a single phase during the addition of solar heat in the solar heat collectors.

Referring to FIG. 1, solar heat can be collected with solar concentrating heat collectors such as those using solar trough technology or other suitable solar heat collecting devices. In embodiments of solar heat systems using solar trough technology, the sun's energy “line” can be focused on a heat collection element. In some embodiments, the heat collection element can comprise a pipe containing a thermal transfer fluid having thermal properties suitable for the collection of high temperature heat. Once the sun's energy has been focused and concentrated on the heat collection element, the energy can be collected in the solar heat transfer fluid, which in some embodiments can be an oil designed to withstand high temperatures (e.g. 730-750 F). Typically, in the past, a commercially available synthetic oil, a biphenyl and diphenyl oxide called Therminol, has been used although other types of heat transfer fluids may be appropriate depending on the operating conditions and economics.

The hot solar heat transfer fluid can be pumped into an optional storage system, that can provide both storage for extended operation, or storage that can allow for higher outputs of thermal energy for shorter durations. The control and dispatch of the hot solar heat transfer fluid from the storage system to heat the feedwater can be based on the time of delivery (TOD) value of the energy produced by the Rankine cycle. The dispatch control of the hot solar heat transfer fluid to the solar feedwater heater can be defined by the amount of solar heat that can be delivered as a result of the sun's energy collected in the storage system and the time period over which the energy can be delivered.

With continued reference to FIG. 1, heated solar heat transfer fluid 12 can be directed to the solar feedwater heater X, which provides heat in addition to or in substitution for the heat provided by the steam extraction 14. The solar feedwater heater X can be a closed feedwater heater such as a tube and shell fluid heater, and can be placed serially in the feedwater chain immediately upstream of the last high pressure heater H1. Typically, the hot solar heat transfer fluid can be on the “shell side” of the feedwater heater and the feedwater, because it can be a much higher pressure fluid, can be on the “tube side” of the solar feedwater heater X. By adding more solar heat than the extraction steam 14 provides to the high pressure heater, an increase in the feedwater flow 16 temperature to the boiler economizer can be realized, typically resulting in greater efficiency to the host Rankine cycle.

The solar collectors can be designed to boost the temperature of the feedwater that enters the boiler to a specific design temperature, or even to a higher temperature depending on the ability of the boiler to absorb the additional heat. It is anticipated that most retrofit applications can consist of substituting heat provided by the hot solar heat transfer fluid 12 for the extraction steam 14. In this manner, design operating parameters of the boiler can be maintained and additional generating capacity can be realized, since more steam can then be available to expand through the steam turbine. Alternately, the turbine capacity can remain the same and fossil fuel usage can be reduced, having been replaced by solar heat. The cooled solar heat transfer fluid can then be returned to the solar heat collectors for reheating.

It is noted that in using a single phase solar heat transfer fluid, all of the feedwater heating can be provided by solar sensible heat and that the temperature difference between the two fluids is much closer than using superheated extraction steam. The use of superheated steam in the extraction flow to heat feedwater, which is at a much lower temperature, results in an entropic loss to the Rankine cycle.

With continued reference to FIG. 1, the solar feedwater heater X can be installed upstream and in series with the existing high pressure heater H1 and downstream of the low pressure feedwater train (a typical heater train is shown in FIG. 1 as heaters H2, H3, H4, and H5), which is used in a typical Rankine cycle to preheat the condensate 18. In this manner, when there is no heated solar heat transfer fluid 12 provided by the solar collector, the feedwater can merely pass through the solar feedwater heater X, having already been pre-heated with the conventional feedwater train, the only penalty being a small feedwater pressure drop through the added solar feedwater heater X. The amount of heat and temperature added to the feedwater can be controlled through the use of valves 20 and 22. If a storage system is used, valves 24 and 26 and can also be used to modulate and regulate the solar heat transfer fluid to the solar feedwater heater X and the storage system, as required.

Cold solar heat transfer fluid 28 can be returned to the solar heat collectors and the reheated hot solar heat transfer fluid 30 can be directed to a storage 32, if used. The modulated hot solar heat transfer fluid 12 can then be fed to the solar feedwater heater X. Alternately, the solar feedwater heater X can be installed in parallel with the existing heaters with appropriate valving for when the heater is in use and when it is not. In both cases, cold solar heat transfer fluid 34 can be returned to the solar loop for reheating. Isolation valves 36, 38 can also be provided for extraction steam 14 and heater drains 40.

With continued reference to FIG. 1, the solar heat collectors can be a single axis tracking trough design or some other form of solar heat collectors that collect insolation and deliver the collected heat in the form of a single phase heat collection fluid to the feedwater train of the host plant. The solar heat collectors can be controlled and operated based on real time needs of the host plant as well as the anticipated needs of the system.

A bleed line 42 can also be used in the system to provide continuous heating. The bleed line 42 can allow a small fraction of the extraction steam 14 directed to the feedwater heater that is being supplemented by solar heat to be re-directed to a lower pressure feedwater heater. Typically, this line can be of small diameter to permit, for example, approximately 1 or 2% of the full load extraction steam 14 to be redirected to the lower pressure heater. In order to preclude bleed steam flow during periods of low or no solar heat input into the solar feedwater heater X, a valve can be placed in the bleed line. In this manner, a small and continuous steam flow can result that is sufficient to maintain heat in the steam extraction line and the feedwater heater that is being supplemented by the solar feedwater heater X immediately upstream of the steam extraction heater.

If the above-described solar heating is applied to new power generation systems, the boilers in the new systems can be designed to receive higher feedwater temperatures. In this manner, efficiencies more closely resembling Carnot efficiencies can be achieved, since the feedwater temperature can be closer to the feedwater's saturation temperature. In addition, higher turbine capacity can be designed into a unit and the higher extraction steam flow expanding through the turbine can result in higher overall turbine flows and higher outputs.

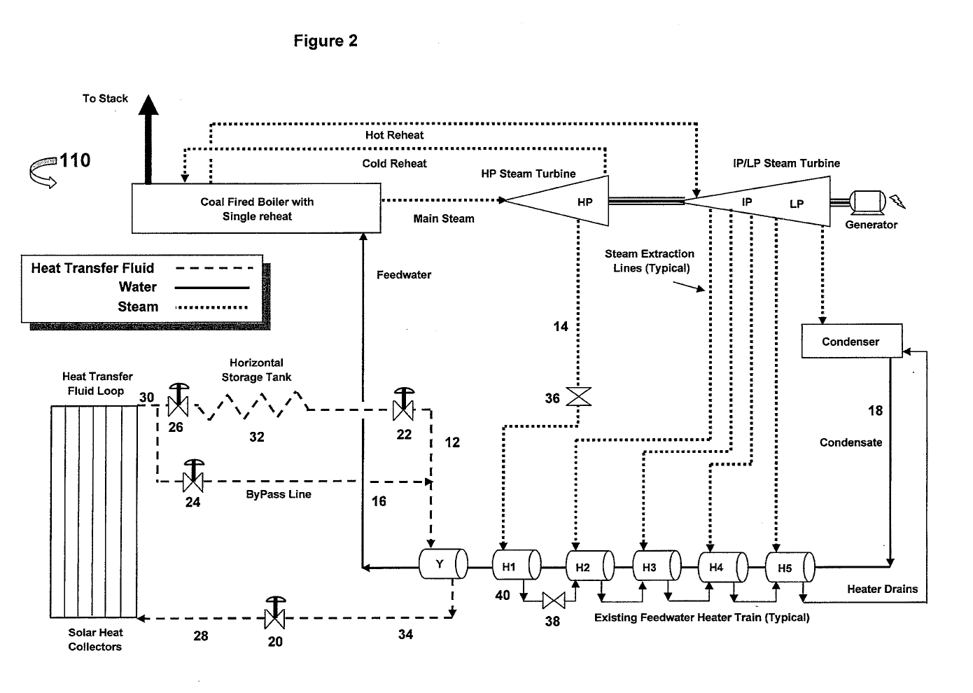

With reference to FIG. 2, another embodiment of a system, 110, can include a solar feedwater heater Y alternatively placed serially downstream of the high pressure feedwater heater. By placing a solar feedwater heater downstream of the high pressure feedwater heater, the amount of feedwater flow 16 temperature and heat delivery to the boiler economizer can be adjusted to optimize efficiency of the host plant. This is the result of the cycle more closely approximating the Carnot cycle, in which heat is added in the boiler at a higher temperature than otherwise would have resulted. The amount of heat and temperature added to the feedwater can be controlled through the use of, for example, valves 20, 22, 24, and 26.

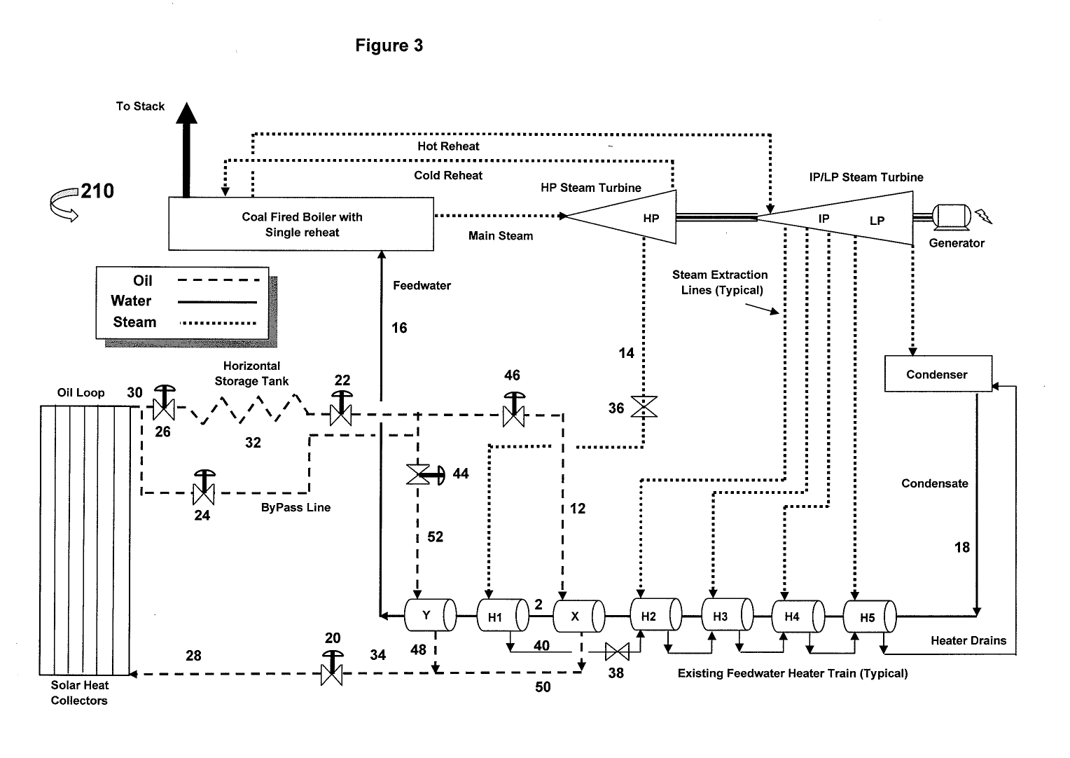

With reference to FIG. 3, another embodiment of a system, 210, can include two solar feedwater heaters X and Y placed serially before and after the high pressure heater. In this manner, further control can be exercised on how the solar heat is inputted in the host Rankine cycle. Adding heat to the solar feedwater heater X can tend to increase the capacity output of the host Rankine cycle plant and/or decrease fossil fuel consumption. Adding heat to the solar feedwater heater Y can tend to increase the overall efficiency of the host Rankine cycle. Control of the solar heat can be affected by, for example, the valves 22, 44, and 46, which can be modulated to direct solar heat to optimize plant performance. The regulation of these valves can impact the amount of cold solar heat transfer fluid 48, 50 leaving both the solar feedwater heaters and returning to the solar heat collectors, as well as the amount of solar heat 12 delivered to the solar feedwater heater X and solar heat 52 delivered to the solar feedwater heater Y.

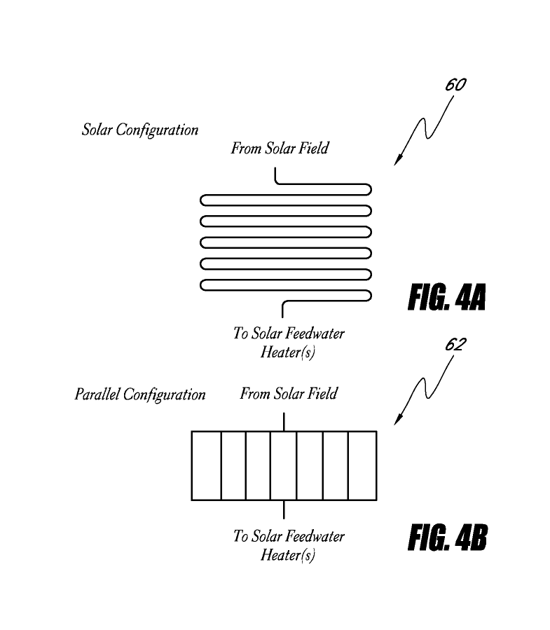

With reference to FIGS. 1-4, the optimal amount of heat collected in the solar heat collectors and delivered to the feedwater can be enhanced through heat storage. The use of storage allows firming of the solar heat to the host plant as well as allowing a certain degree of dispatch. Both firming and dispatch can add economic value. With reference to FIGS. 4A and 4B, two configurations 60 and 62 of a horizontal storage concept are illustrated. In the preferred embodiment 60 shown in FIG. 4A, large diameter piping can be used above ground and can be installed in a circuitous pattern shown such that a large run of pipe is created that exceeds a run of pipe that can ordinarily be required to deliver the solar heat transfer fluid. Within this run of pipe, hot solar heat transfer fluid can be stored.

A horizontal storage tank can provide a buffer to smooth out heat spikes and heat loss from the solar collectors resulting from the sun's transient radiation delivery, and can provide a more firm energy source. In addition, the storage can also allow for dispatch of the solar energy such that higher value “on-peak” energy can be utilized when needed. The horizontal storage tank illustrated in FIG. 4A can consist of commercially available pipe that can be of a diameter larger than required for normal delivery purposes. For example, the solar field can be one mile from the solar feedwater heaters and an economic design to optimize capital costs, energy required to pump the fluid, and the heat loss associated with the pipe diameter can dictate an 18 inch diameter pipe. The pipe diameter can be substantially higher, e.g. 36 inches, and can have a substantially larger run, e.g. 5 miles, of back and forth piping layout in a circuitous fashion, in order to increase the hot solar heat transfer fluid residence time. This example can increase the indigenous storage time by a factor of 16 and can allow for dispatch of solar energy. One method of storage layout piping, where applicable and cost effective, can be use of access roads between the troughs' parabolic mirrors and support structures. In this manner, land use can be minimized and greater access to the storage piping can be realized.

This method of heat storage control can establish a natural thermo plane between the hot solar heat transfer fluid and cold solar heat transfer fluid. A thermo plane is the thermal boundary between the hot solar heat transfer fluid and the cold solar heat transfer fluid. Due to the large aspect ratio between the length to the diameter of the pipe, only minimal amounts of hot and cold solar heat transfer fluid can be mixed together and a uniform flow can be maintained throughout the solar heat collectors and horizontal storage tank. The amount of hot solar heat transfer fluid delivered can be the same amount as the cold solar heat transfer fluid returned and the once through solar horizontal storage piping can perform the function of two tanks that would otherwise be used. One tank can normally be required for hot solar heat transfer fluid and one tank for cold solar heat transfer fluid. In order to provide flexibility and improve system efficacy, a bypass can be provided to allow direct feed from the solar heat collectors to the solar feedwater heater or both the solar feedwater heater and horizontal storgage tank.

With continued reference to FIG. 4B, another embodiment of a horizontal storage tank 62 is illustrated. In this embodiment, the storage piping can be laid out in parallel fashion. Such an arrangement can minimize pumping requirements.

A storage system consisting of 36 inch pipe, 25,000 feet long, can provide a full load of solar heat storage such that a high pressure heater can produce an equivalent of approximately 40 MWe's of a 500 MW coal plant for approximately 3 hours.

The aforementioned description of storage assumes that the storage medium is the same medium that heats the host plant's feedwater. Other types of storage systems exist wherein the solar heat is transferred to another medium or fluid, such as molten salt, and then the heat is re-transferred to an appropriate medium for feedwater heating. While this adds complexity to the system, the method of control and regulation of the storage system can remain the same on a basic principle basis as where a single medium is both the feedwater heater fluid and the storage fluid.

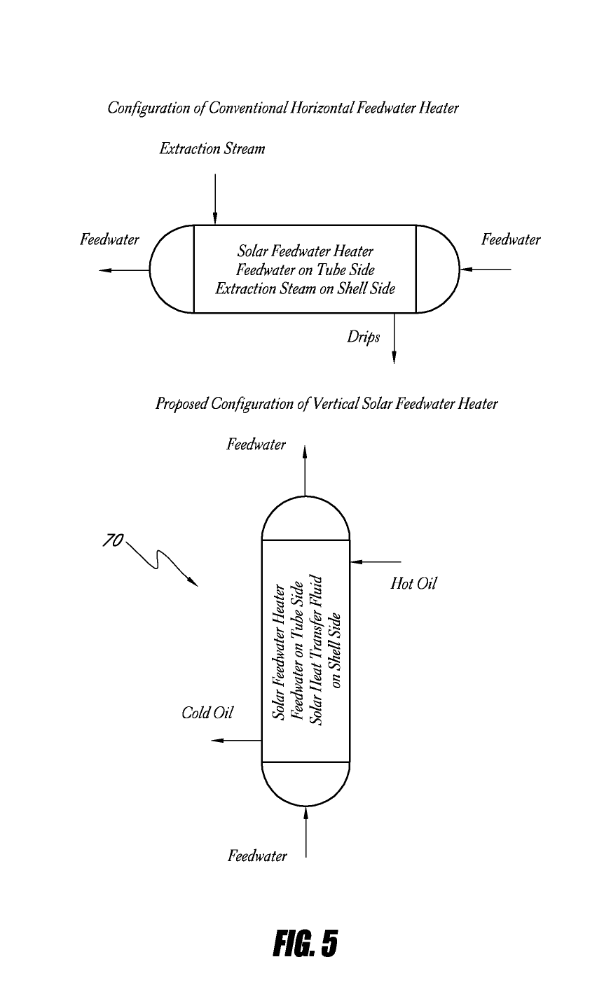

With reference to FIG. 5, a solar feedwater heater 70 can be erected in a vertical fashion. Since the solar feedwater heater is a non-condensing heat transfer device, the amount of heat transfer area can be substantially larger than traditional extraction steam feedwater heaters. Thus, if laid out in a conventional horizontal manner it can require more space. In instances where oil is used as the solar heat transfer fluid, the solar feedwater heater can be a fluid to fluid heat transfer device, and the orientation can be made vertical in order to save floor space. With reference to FIG. 5, a proposed layout of the device is illustrated. The solar feedwater heater is shown in a vertical position with the feedwater on the tube side entering the heater from the bottom and exiting from the top. The solar heat transfer fluid (typically high temperature oil) is shown entering the top of the heater and exiting the bottom resulting in a counterflow heat exchanger. Parallel heat exchangers can also be used, as well as other configurations for the solar feedwater heater in the vertical position.

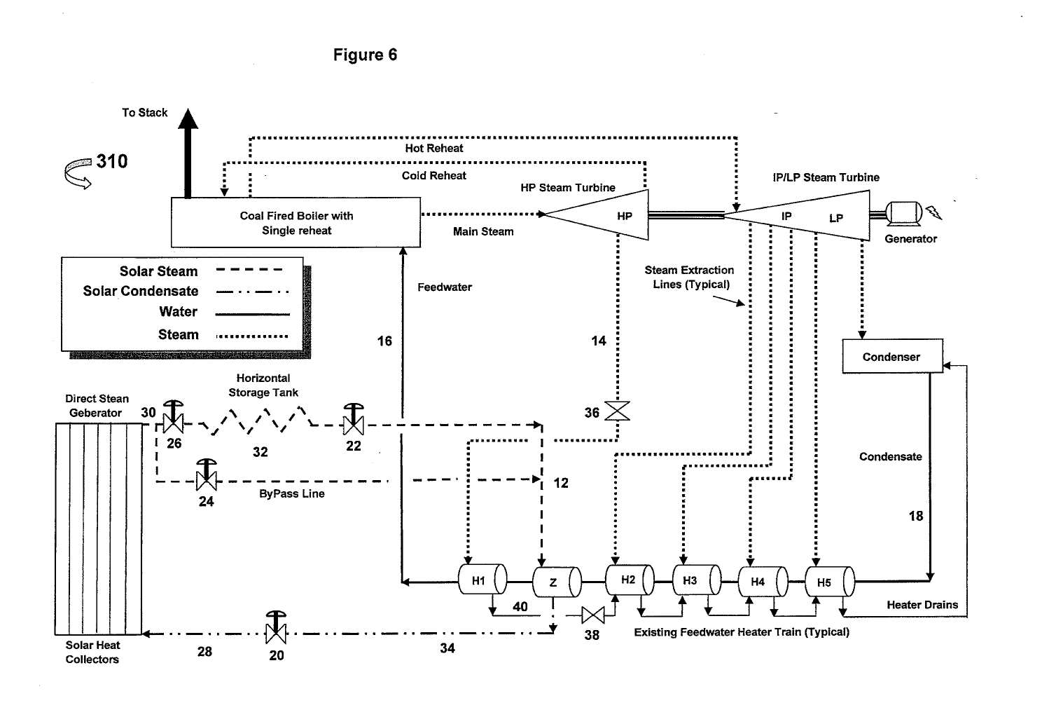

With reference to FIG. 6, another embodiment of a system, 310, using multi-phase feedwater heating control, can also be implemented. One method of providing multi-phase fluid generation for feedwater heating is the conventional trough heating of a single phase fluid which is then used in a separate and standalone solar boiler to produce steam which can be used for feedwater heating. Another alternative to single phase feedwater heating is the application of direct steam generation. In both cases, steam can be generated, monitored, controlled and regulated similar to the methods described for a single phase heating of the host plant's feedwater system. In the direct steam generation method, the solar heat transfer fluid is water or other suitable fluid which is directly vaporized in the solar heat collectors to provide saturated or superheated vapor to the feedwater system. In the direct steam integration method, the water to steam generation can occur in the heat collection element where the sun radiation is focused.

With reference to FIG. 6, the solar heat collectors can receive solar heat transfer condensate from the solar feedwater heater Z. The solar heat transfer condensate taken from the solar feedwater heater Z can then be heated, vaporized and superheated, as required, in an appropriate solar heat gathering system (typically through trough or Fresnel Line types of solar heat collection). The vapor heat can then be directed to storage or directly to the solar feedwater heater Z. As illustrated in FIG. 6, the solar feedwater heater Z can be a separate feedwater heater in order to ensure separation of the fluids between the host plant and the solar system. The primary control different between the multi-phase feedwater heating of the feedwater is that in the multi-phase feedwater heating both a vapor and a liquid are controlled and regulated. However, the basic principles of control, logic, and regulation as with single-phase fluids are still applicable.

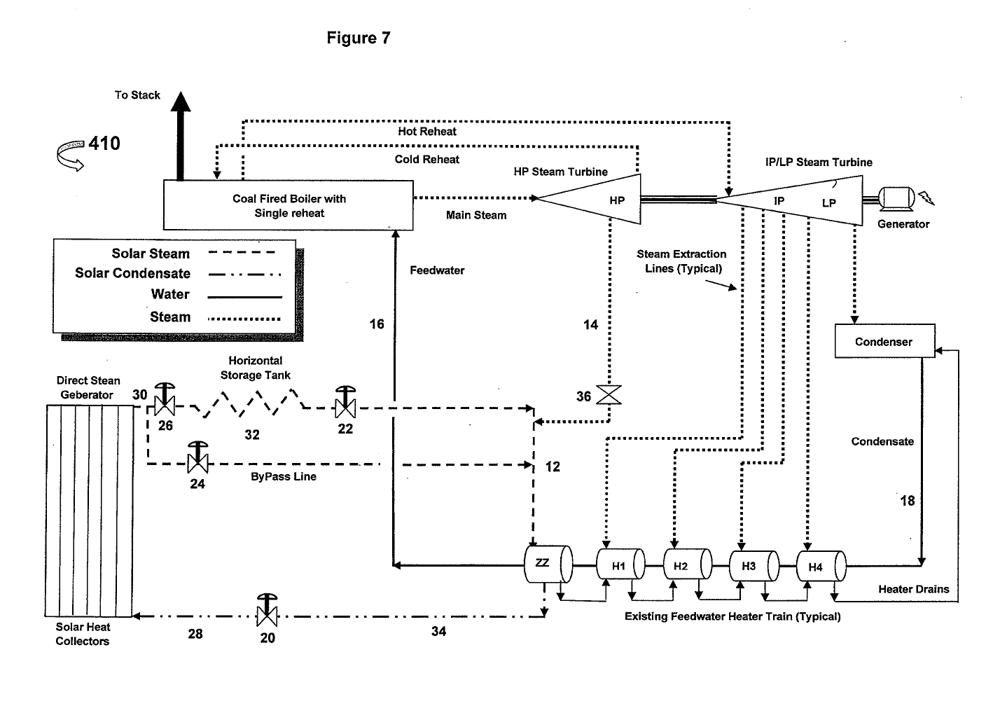

With reference FIG. 7, another embodiment of a system, 410, is illustrated showing direct steam generation, in which extraction steam can be directly replaced with direct steam generation vapor. This system comingles the two vapors, the direct steam generation vapor and the host plant's steam. The basic principles of operation and control as described below can still be applicable.

### Operations and Control

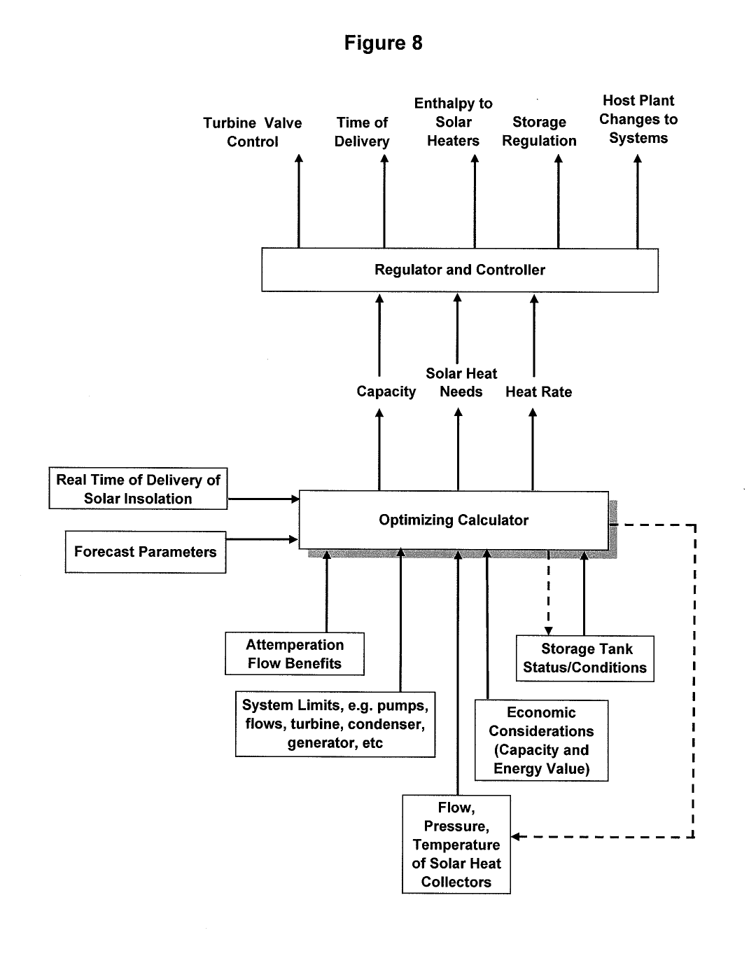

With reference to FIG. 8, an embodiment of an overall process schematic is shown. Certain variables are identified, the schematic illustrating how these variables can be used to provide optimization of solar heat integration into the feedwater of a Rankine cycle power generation system which integrates solar heating.

With reference to FIG. 8, an optimizing calculator can be used with the systems described above to calculate optimization the host plant's capacity, the amount of solar heat needed, and heat rate. The host plant's needs, the plant's turbine capacity, heat rate, and when the solar heat is required can change, and from time to time, greater emphasis and value can be placed on each of these. The optimizing calculator can, in practice, be represented by a supervisory, control and data acquisition (SCADA) system which allows the operator to optimize the plant's capacity, heat rate and solar heat requirements. If storage is not included in the process, then the solar heat collectors can still be optimized in real time conditions to harvest as much solar energy as possible, which can then be supplied directly to the solar feedwater heaters.

With continued reference to FIG. 8, the real time delivery of solar insolation can be used to determine how much energy is being collected during any specific period. The forecast parameters, as discussed in more detail below, can determine when the use of the heat is required for proper management and regulation of storage and the real time and future time use of the heat. The attemperation flow benefits for both superheat and reheat steam can be the result of solar feedwater heating since both the superheat and reheat attemperation flow rates can be reduced or eliminated as a result of providing solar heat to the host plant's feedwater system. These benefits and the amount of impact can change from one host plant to another.

With continued reference to FIG. 8, the unit restraints and impacts (e.g. pumps, flows, turbine, generator, etc.) can be those limitations of the host plant that are considered when dispatching solar heat into the host plant's feedwater system. For example, if the condenser back pressure is a limiting factor, then a turbine control valve or valves can be used to reduce steam flow through the machine. In at least some embodiments, the flow, pressure, and temperature of the solar heat collectors can be the parameters that can be used for solar field and storage control. In some embodiments, this can include feedback to the optimizing calculator.

With continued reference to FIG. 8, economic considerations, such as capacity and energy values, can be the economic inputs used to assign real time and forecasted values in determining how the solar heat collectors are operated and storage facilities utilized. The storage tank status and conditions can represent the current and projected amount of heat that is stored and the amount of heat that can be stored at desired temperatures, and can also have feedback to the optimizing calculator.

With continued reference to FIG. 8, once the value and specific desired capacity, heat requirements, and calculated heat rates have been determined, the supervisory logic of a regulator and controller system can perform the necessary functions to achieve calculated goals. Other components and systems can also be regulated and controlled through use of the optimizing calculator, regulator, and controller, including speed pump regulation for feedwater control, fuel feed and delivery, boiler damper adjustment, and the setting of attemperation flow rates for both superheat and reheat.

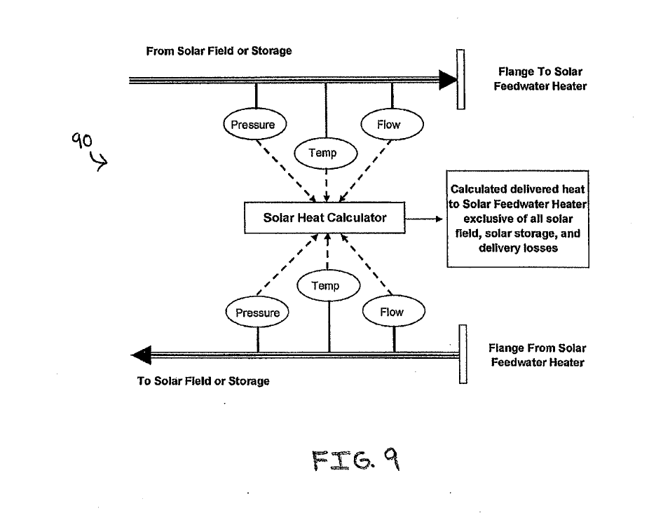

With reference to FIG. 9, in order to properly regulate the amount of solar energy delivered to the host plant and to provide accurate cost accounting, the amount of solar heat that is actually delivered, exclusive of losses, to the feedwater system can be calculated. Measurements of the solar heat transfer fluid's flow, pressure, and temperature at the last flange to the solar feedwater heater (e.g. solar feedwater X in FIG. 1), and measurements of the solar heat transfer fluid's flow, pressure, and temperature at the first flange leaving the solar feedwater heater can be used in an algorithm to calculate the amount of solar heat delivered. In at least some embodiments, these measurements can be made with sensors located throughout the system.

The heat delivery to the last flange before the solar feedwater heater can typically represent the properties of the hot solar heat transfer fluid, and the remaining heat content in the fluid after the first flange leaving the solar feedwater heater can typically represent the properties of cold solar heat transfer fluid. As part of the algorithm, the physical properties of the heat transfer fluid can be used in order to correctly calculate the amount of heat delivered. The algorithm can be used in the optimizing calculator described above, and/or in the Central Processing Units (CPU) and control methods described below in order to calculate the real time heat delivery of solar heat to the host plant's feedwater system, as well as the heat delivery over any set time period.

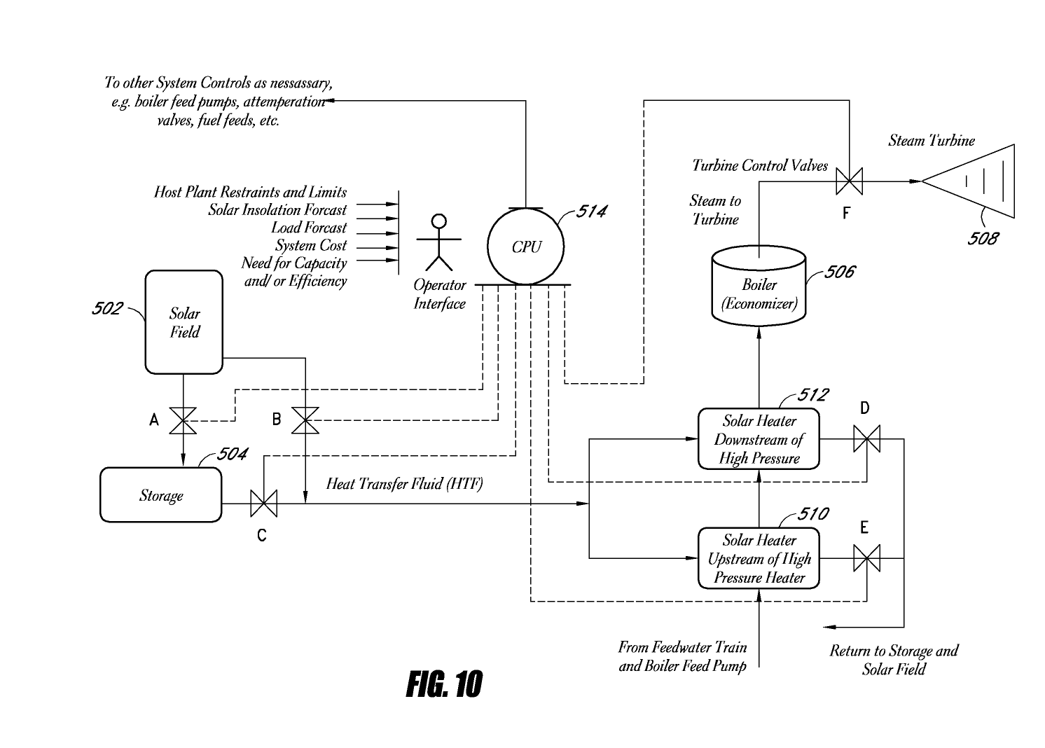

With reference to FIGS. 10-13, information and control methods for use with a Rankine cycle power generation system that incorporates solar heating are illustrated. With these control methods, the host plant operator can control and adjust the solar heat transfer fluid in such a manner as to produce maximum capacity (e.g., output), maximum efficiency, or a modulated proportion of capacity and efficiency. Storage capability, which is optional in the systems described herein, can allow the heat transfer fluid to be dispensed during periods of high value at the discretion of the operator. In addition, while two solar feedwater heaters are illustrated in FIG. 10, the information and control methods can be used with any number of solar feedwater heaters.

With particular reference to FIG. 10, a Rankine cycle power generation system 500 can include a solar field 502 (which can include a plurality of solar collectors as previously described), solar storage unit 504, boiler (economizer) 506, steam turbine 508, solar feedwater heaters 510 and 512, and electronic control unit, or central processing unit (CPU) 514, which can comprise or include an optimizing calculator such as the one described above. Also included are valves for the system, labeled A-F. Valve A can control, or regulate, the amount of heat transfer fluid moving from the solar field to the storage unit. Valve B can control the amount of heat transfer fluid moving directly from the solar field to the solar feedwater heater(s). Valve C can control the amount of heat transfer fluid moving from the storage unit to the solar feedwater heater(s). Valve E can control the amount of heat transfer fluid which enters the solar feedwater heater 510 located upstream of the high pressure heater. Valve D can control the amount of heat transfer fluid which enters the solar feedwater heater 512 located downstream of the high pressure heater.

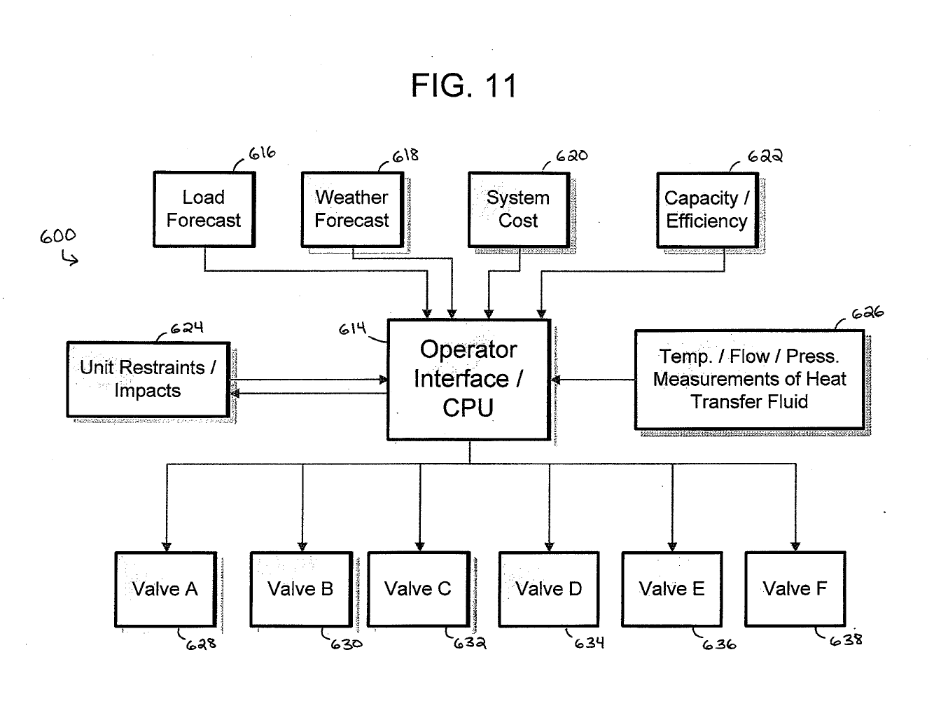

With reference to FIG. 11, a control schematic 600 is illustrated. The CPU 614 (which can be identical to that of the CPU 514 in FIG. 10), can include an operator interface, and can receive numerous inputs and information, including but not limited to information about load forecast 616, weather forecast 618, system cost 620, capacity and efficiency needs 622, unit restraints and impacts 624, and temperature, flow, and pressure measurements collected from a sensor or sensors 626. These inputs, which can be fed into the CPU either through operator input or through a combination of operator input and sensors in the system, can aid in formulating a control sequence which activates one or more of valves 628 (valve A), 630 (valve B), 632 (valve C), 634 (valve D), 636 (valve E), and 638 (valve F). The CPU also has unit restraints that must be observed, e.g. temperature and flow limitations and some Rankine unit equipment and systems may require adjustments, through the CPU, e.g. feedwater flow, fuel delivery, as a result of the added solar heat.

With continued reference to FIG. 11, an operator can input information needed in order to dispatch and run a Rankine cycle power generation system with solar heat integration within specified limits. Typically, this information can be time dependent and based on day ahead scheduling in order to satisfy Independent System Operator dispatch requirements or entities regulating the power grid.

As described above, this information can consist of, in part, the load forecast 616, which can be received from the grid regulating entity. Typically, load forecasts are made on a 24 hour basis on an hour ending basis, i.e. hours ending 1-24 on a day ahead basis. This can include forecasts for both capacity needs (in Megawatts) and energy forecasts (in Megawatt-hours). Some grid dispatch systems use an “all-in” approach where the capacity and energy are valued as a single product value.

With continued reference to FIG. 11, the operator can input into the CPU the load forecast 616 received from the grid regulating entity. If for some reason the solar plant doesn't deliver the promised capacity and energy (e.g. an foreseen cloud cover precludes delivery), then there can be an “imbalance” with regards to what was promised and what was delivered. Generally, this imbalance can be reconciled, normally at the end of each month.

With continued reference to FIG. 11, the operator can also input information into the CPU about a solar insolation forecast 618, which is a weather forecast regarding how much insolation can be expected for the day's operation. For example, the forecast can be the regular weather forecast which indicates cloudiness or storms, or in some embodiments can comprise more sophisticated insolation models. This forecast can help the operator determine what amount of solar heat will be available for use.

With continued reference to FIG. 11, the operator can also input information about system cost 620, which represents the expected cost of generation. The overall system can be dispatched on a cost basis, normally using increments of, for example, 5 MW's for larger systems and smaller increments for smaller systems. The system load can be increased or decreased based on the minimal cost or maximum savings to load or unload each unit in the system. For example, each unit that is on the system can be evaluated based on a pre-determined ranking order and, based on an assumed 5 MW increment, a determination can be made whether a particular unit results in the lowest cost to be dispatched as compared to all the other units on the system.

Since solar energy is “free” from a dispatch perspective, it is generally given preference. For example, the solar plant can submit its day ahead projected delivery of capacity and energy on a 24 hour ending basis. The solar plant can most likely prioritize capacity delivery, since most grids use natural gas for peaking and the solar unit, by providing extra capacity, can be offsetting high value natural gas. However, system costs for both capacity and energy can normally be identified on an hourly basis, and the solar plant can determine the most valuable “need” of the system and provide its capacity and energy accordingly on the day ahead protocol basis.

With continued reference to FIG. 11, the operator can also input information 622 into the CPU about a need for capacity or efficiency. This need can be determined by the operator himself or herself. For example, the operator can determine whether the plant will be dispatched for optimizing efficiency, capacity, or a mixture of both. The need for capacity can normally be prioritized over the need for efficiency based upon projected system cost. However, unit limitations, system needs, and the value of Renewable Energy Credits (REC) can also be taken into account in determining whether the system is dispatched on an efficiency basis (e.g. where the solar energy displaces the unit's fuel burn) or provides capacity (e.g. where the solar energy displaces the system's fuel burn).

Capacity and energy have a projected and real time value, and the solar plant can plan its delivery of capacity and energy on a day ahead basis on the basis of these forecasted values. It is this respective value between capacity and energy, subject to the unit's capability and limitations that can determine how the unit is dispatched. However, as noted above, the priority can normally be “capacity.”

Additionally, there can also be ancillary products such as pure capacity, i.e. standby capacity with no energy, regulation and black start capability that have value, but solar plants rarely provide these types of ancillary products due to the inherent limitations of solar plants only being capable of providing energy when the sun is shining (assuming no storage).

As noted above, the valves A-F of the system can normally be adjusted such that maximum capacity is prioritized due to its high system value. Consequently, the solar plant can almost always be configured such that maximum capacity is delivered. The value for capacity is very high, since, as noted above, running the solar plant for capacity can displace the system cost, which normally would be based on natural gas. In addition, a solar plant that is configured for maximum capacity can also displace new generation equipment that would not have to be built. This advantage provides additional value.

However, if unit restraints and impacts are at issue, then the unit can modulate the valves A-F to ensure that the solar heat input does not negatively impact or jeopardize unit operation. For example, and with reference to FIG. 11, unit restraints and impacts 624 can entail things like attemperation flow rate control, feedwater flows, turbine steam flows, back pressure limitations, etc. The modulation of the valves A-F can more likely be necessary for unit control as opposed to meeting the system needs. Unit safety, control and stability are prioritized over system needs. Consequently, the operator can not only determine whether the solar plant should be prioritized for capacity or efficiency, but can also note any unit limitations that may occur as a result of the product delivery to the system. Normally, once the day ahead schedule is inputted, the automatic control system described herein can dispatch the solar plant and provide the necessary changes to the unit's operating parameters within the unit limits as set by the operator.

As described above, the unit restraints and impacts 624 can include boiler feed pump flow and pressure, attemperation flow, fuel delivery, condenser back pressure changes, and other unit parameters that can be impacted as a result of solar heat added to the cycle. The changes and adjustments to these components and systems can be made automatically in self-adjusting controls schemes, or can require additional information from the CPU to execute the adjustments. However, these adjustments can commonly be made using existing control technology and protocol, and adhering to normal industry standards.

With continued reference to FIG. 11, the CPU can also receive information 626, for example by sensors located throughout the system, of the temperature, flow rate, and pressure of the heat transfer fluid. As described above, measurements of the solar heat transfer fluid's flow, pressure, and temperature, for example, at the last flange to the solar feedwater heater (e.g. solar feedwater X in FIG. 1), and measurements of the solar heat transfer fluid's flow, pressure, and temperature at the first flange leaving the solar feedwater heater can be used in an algorithm to calculate the amount of solar heat delivered. This information can be inputted to the CPU so that the CPU can appropriately adjust any of valves A-F in order to increase or decrease the amount of heat being delivered to the solar feedwater heater.

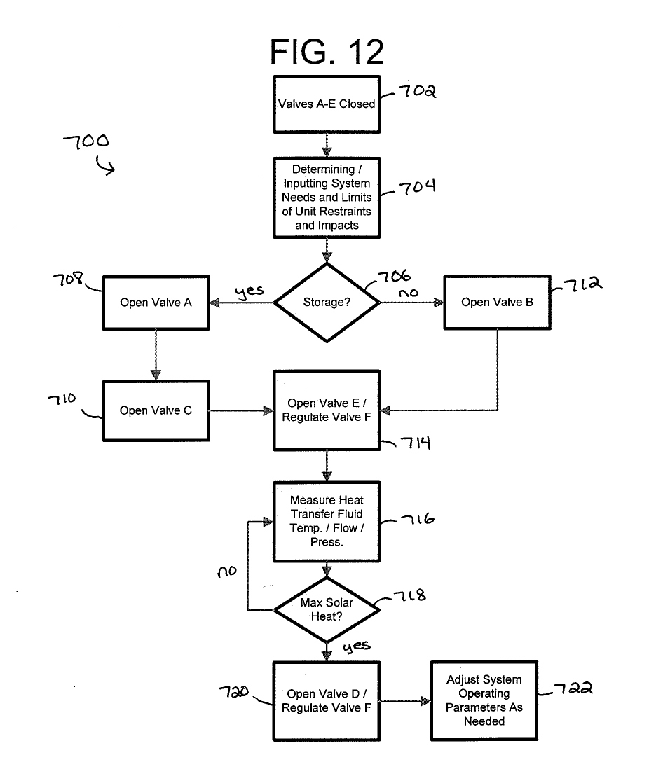

With reference to FIGS. 10, 11, and 12, and particularly with reference to FIG. 12, a control routine 700 which maximizes turbine capacity in the system can be implemented by the CPU 614. During the control routine 700, and with reference to operation block 702 in FIG. 12, the valves A-E can first be closed by the CPU 614.

With reference to FIGS. 11 and 12 and operation block 704, the operator can determine system needs, as well as the limits of unit restraints and impacts as described above. Once this is accomplished, the CPU 614 can begin to control and adjust valves A-F.

With reference to decision block 706, the CPU 614 can determine whether or not storage of solar energy is being used. As discussed above, solar energy storage is optional in the Rankine cycle power generation systems described herein.

If storage is being used, and assuming, for example, that the capacity will be required in a time frame that occurs after the day's maximum solar insolation period, then an appropriate amount of heated heat transfer fluid can be directed from the solar heat collectors to the storage by opening Valve A, as illustrated by operation block 708. The opening of valves A-E and adjusting Valve F, as described in these control routines, can be actuated via the CPU 614.

The amount of heat released from the solar collectors at this time can be regulated. The regulation can be based on measurement of the pressure, flow, and temperature of the heat transfer fluid running through the solar heat collectors. The solar heat collectors can thus be regulated in consideration of the current and projected heat applications, and the temperature, flow, and pressure of the heat transfer fluid can be monitored as the heat transfer fluid moves to and from the storage tank and solar feedwater heaters, similar to how the solar heat transfer fluid can be monitored as it enters and leaves the solar feedwater heaters.

With continued reference to FIG. 12, after a predetermined time, stored solar heat can be dispatched to the host plant by opening Valve C, as illustrated by operation block 710. Valve C, as described above, can allow the heated heat transfer fluid to move from the storage area to the solar feedwater heaters.

Depending on the time when solar heat is required, direct solar heat can also be dispatched. For example, and with reference to operation block 712, Valve B can be opened if the system does not include storage, or if additional heat is needed.

If maximum capacity is required, than as much solar heat as possible can be directed to the solar feedwater heater located upstream of the high pressure heater by opening Valve E, as illustrated by operation block 714.

With reference to operation block 716 in FIG. 12, and also to FIGS. 9-11, the CPU 614 can receive and process information about the amount of heat that is being introduced to the solar feedwater heater through measurements of the heat transfer fluid's temperature, pressure, and flow as the fluid both enters and leaves the feedwater heater. These measurements can provide the CPU with information about the amount of heat being delivered to the solar feedwater heater at any given time.

With reference to decision block 718 in FIG. 12, the CPU 614 can check to see if a maximum, or desired, heat level has been reached in the solar feedwater heater.

If the CPU determines that the solar feedwater heater has reached a maximum, or desired heat level, then Valve D can be opened, as illustrated by operation block 720. Once any solar heat is dispatched to the host plant's Rankine cycle, i.e. when either Valve “D” or “E” is open or both Valves “D” and “E” are open, adjustments can be made to the steam flow going to the turbine by adjusting Valve “F”.

For example, and with reference to operation blocks 714 and 720 and FIGS. 10 and 11, Valve F can be adjusted to ensure that steam flow going to the turbine is modulated to account for the additional enthalpy received by the host plant's Rankine cycle resulting from the addition of solar heat. Typically, the turbine control valve F can, in actuality, be a series of parallel valves that control the amount of steam flow to the turbine.

With continued reference to FIG. 12, the turbine control valve F, which can be adjusted, can determine the amount of steam allowed to move through the high pressure turbine. The turbine control valve F can also help determine the condensate/feedwater flow rate, and the amount of turbine capacity resulting from the solar contribution. The turbine control valve F can be regulated to limit the turbine output, or limit flow to the condenser in those cases where condenser back pressure may preclude an increase in turbine output. In these cases, the turbine control valve F can be regulated such that the amount of solar heat inputted into the host Rankine cycle can be used for a fossil fuel displacement. In at least some embodiments, the turbine control valve F can, for ease of operation, be set for a predetermined flow rate.

With reference to FIGS. 1 and 10, the amount of extraction steam 8 can influence capacity, along with regulation of the turbine control valve F. Extraction steam 8, which can be taken from the turbine after partial expansion, can be directed to the feedwater heaters to pre-heat the feedwater. The amount of steam extraction delivered to the host plant's feedwater heater immediately upstream from the solar feedwater heater X can be controlled by the amount of solar heat delivered to the solar feedwater heater X. As described above, the amount of heat delivered can be controlled by both the temperature of the hot solar heat transfer fluid and the flow rate. As the temperature of the feedwater is increased due to solar heating, the amount of extraction steam supplied to the upstream heater can decrease. This reduction can result from the inability of the extraction steam to condense at a higher feedwater temperature. In this manner, the turbine capacity can be increased since more steam can now be directed through the turbine.

Alternately, the steam extraction flow to the upstream heater from the solar feedwater heater X can be increased by reducing the amount of enthalpy, through either temperature and/or flow reduction, delivered to the solar feedwater heater X. Such control allows for optimization of the turbine output given the amount of solar heat being collected in real time, the amount of solar heat expected to be collected in the near term during the day and the amount of solar heat stored indigenously in the solar heat collectors and/or in the storage system.

With continued reference to FIG. 12, once valves E and D have been opened, the CPU 614 can adjust system operating parameters as needed, as illustrated in operation block 722. For example, the CPU can adjust a capacity parameter and/or an efficiency parameter and open and/or close one or more of valves A-F to account for changes in fuel feed and pump flows which occur as a result of solar heat being added to the system.

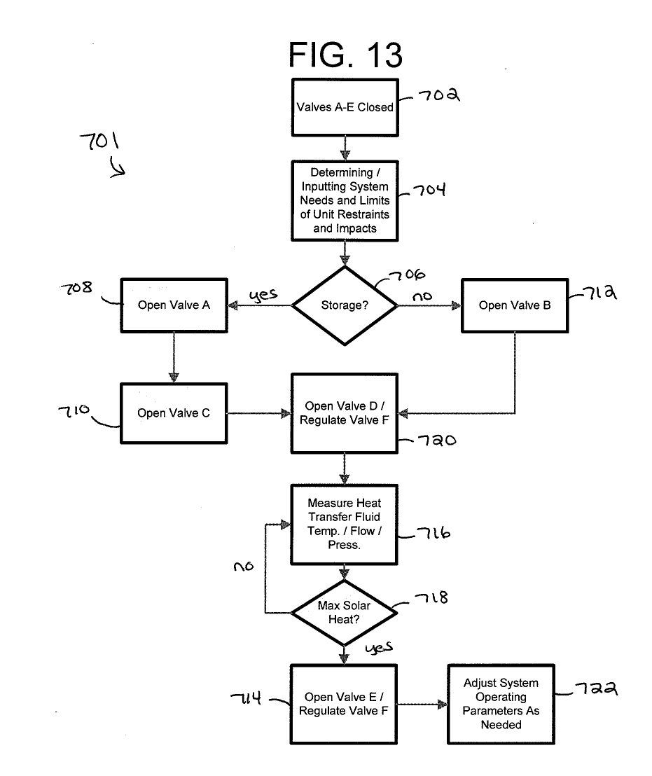

With reference to FIGS. 10, 11, and 13, and particularly with reference to FIG. 13, an information and control method can be used to implement a control routine 701 which maximizes turbine efficiency in the system. The operator can receive the same information as he or she did for maximum capacity from the same regulating entity, including load forecast, solar insolation forecast, and system cost, and most of the operation and decisions can remain the same as that in control routine 700.

For example, and with reference to FIG. 13 and operation block 702, the valves A-E can first be closed. This can be accomplished, again, by activation from the CPU 614.

With reference to operation block 704, the operator can determine system needs and the limits of unit restraints and impacts. Once this is accomplished, the CPU 614 can be used to control and adjust valves A-F.

With reference to decision block 706, the CPU can determine whether or not storage of solar energy is being used. As discussed above, solar energy storage is optional in the Rankine cycle power generation systems with solar heat integration as described herein.

If storage is being used, then an appropriate amount of heated heat transfer fluid can be directed to the storage by opening Valve A, as illustrated by operation block 708.

After a predetermined time, stored solar heat can be dispatched to the host plant by opening Valve C, as illustrated by operation block 710. Valve C, as described above, allows the heated heat transfer fluid to move from the storage area to the solar feedwater heaters.

Depending on the time when solar heat is required, direct solar heat can also be dispatched. For example, and with reference to operation block 712, Valve B can be opened if the system does not include storage, or if additional heat is needed.

If maximum capacity is required, than as much solar heat as possible can be directed to the solar feedwater heater located upstream of the high pressure heater by opening Valve E, as illustrated by operation block 720.

With reference to operation block 716 in FIG. 13, and also to FIG. 9, the CPU can receive and process information about the amount of heat that is being introduced to the solar feedwater heater through measurements of the heat transfer fluid's temperature, pressure, and flow as the fluid both enters and leaves the feedwater heater. These measurements can provide the CPU with information about the amount of heat being delivered to the solar feedwater heater at any given time.

With reference to decision block 718 in FIG. 13, the CPU can check to see if a maximum, or desired, heat level has been reached in the solar feedwater heater.

If the CPU determines that the solar feedwater heater has reached a maximum, or desired heat level, then Valve E can be opened, as illustrated by operation block 714. Once any solar heat is dispatched to the host plant's Rankine cycle, i.e. when either Valve “D” or “E” is open or both Valves “D” and “E” are open, adjustments can be made to the steam flow going to the turbine by adjusting Valve “F”.

For example, and with reference to operation blocks 720 and 714, Valve F can be adjusted to ensure that steam flow going to the turbine is modulated to account for the additional enthalpy received by the host plant's Rankine cycle resulting from the addition of solar heat.

With continued reference to FIG. 13, once valves D and E have been opened, the CPU 614 can adjust system operating parameters as needed, as illustrated in operation block 722. For example, the CPU can adjust a capacity parameter and/or an efficiency parameter and open and/or close one or more of valves A-F to account for changes in fuel feed and pump flows which occur as a result of solar heat being added to the system.

In addition to controlling the turbine control valve F, other valve strokes and other operational unit adjustments for solar heat delivery to the unit can be made based on the unit's restraints and impacts 624 as described above, as well as system needs. For example, one impact that can occur when the valves are set to maximize capacity (e.g. control routine 700) is that the unit's reheat temperature can be dragged down by the solar energy input into the solar feedwater heater located upstream of the unit's high pressure heater. Consequently, the amount of solar heat allowed to flow into this heater, as controlled by the appropriate valve, can be reduced in order to maintain reheat temperature. Consequently, more heat can be directed to the solar feedwater heater located downstream of the unit's high pressure heater.

As described above, generally the valves A-F can be operated in such a manner as to provide as much capacity to the system as possible. System limits and needs can be taken into account, including what fuel is being used on the margins, the system value of energy and capacity, transmission restraints, and the need for renewable energy credits (REC's). By and large, these system restraints (or needs) can be known on a “day ahead” basis and the solar “day ahead” input consisting of the capacity and energy 24 hour ending inputs for energy and capacity can be made a day before the capacity and energy are delivered. However, at least in some embodiments the bulk of the valve operations that can allocate solar energy input upstream and downstream of the unit's high pressure heater can be used to maintain unit operational control and integrity.

The control routines described above constitute methods through which control of the unit can be achieved. However, other methods using the identified inputs of insolation forecast, load forecast, system costs, need for capacity or energy, and/or unit restraints and impacts can also be employed to integrate and regulate solar heat into a cycle. These methods can evaluate the system needs and, within unit limits, dispatch solar heat into the feedwater system to maximize value while maintaining unit operational integrity.

The control concepts described herein can be applied to both new and existing power generation systems. By using the systems and methods described herein, optimization of use of solar heat, heat flow, efficiency, capacity, and time of delivery can be achieved. The integration of solar heat as described above can be used to duplicate existing boiler economizers' temperature requirements, or can adjust economizer entry temperature up or down depending on the need.

Additionally, the controls described above can have minimal intrusion into the design of existing Rankine operating cycles. There can be little to no new pieces of control hardware needed for development, since most if not all of the instrumentation and control equipment used in the control concepts described above can be commercially available.

Although these inventions have been disclosed in the context of certain preferred embodiments and examples, it will be understood by those skilled in the art that the present inventions extend beyond the specifically disclosed embodiments to other alternative embodiments and/or uses of the inventions and obvious modifications and equivalents thereof. In addition, while several variations of the inventions have been shown and described in detail, other modifications, which are within the scope of these inventions, will be readily apparent to those of skill in the art based upon this disclosure. It is also contemplated that various combinations or sub-combinations of the specific features and aspects of the embodiments can be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

What is claimed is:

1. A control system for use in a Rankine cycle power plant that integrates solar heating, comprising:
a fossil fueled boiler configured to heat feedwater into steam and to reheat steam;
a high pressure steam turbine operatively connected to the boiler and configured to receive steam from the boiler, wherein a portion of the steam received by the high pressure steam turbine is directed back to the boiler for reheating after passing through the high pressure steam turbine;
a low pressure steam turbine operatively connected to the high pressure steam turbine and configured to receive steam from both the high pressure steam turbine and reheated steam from the boiler;
a generator operatively connected to the low pressure steam turbine;
a condenser operatively connected to the low pressure steam turbine and configured to condense the steam from the low pressure steam turbine into feedwater;
a feedwater train operatively connected to the condenser and configured to receive the feedwater from the condenser, the feedwater train comprising a plurality of feedwater heaters and at least one solar feedwater heater, the at least one solar feedwater heater serially configured to heat the feedwater moving through the feedwater train with a solar heated heat transfer fluid;
a plurality of extraction lines connecting the high pressure and low pressure steam turbines to the plurality of feedwater heaters in the feedwater train, the plurality of extraction lines configured to direct extraction steam from the high pressure and low pressure steam turbines to the plurality of feedwater heaters in order to heat the feedwater moving through the feedwater train;
at least one heater drain connecting at least one feedwater heater to another feedwater heater in the feedwater train, the at least one heater drain configured to drain at least a portion of the feedwater moving through one feedwater to a lower pressure feedwater located in the feedwater train;
at least one bleed line connecting at least one feedwater heater to another feedwater heater in the feedwater train and configured to direct a fraction of the extraction steam from one of the extraction lines to another, lower pressure feedwater heater in the feedwater train;
a plurality of solar collectors configured to receive solar energy and transfer the solar energy to the solar heat transfer fluid so as to heat the solar heat transfer fluid;
a solar storage tank operatively connected to the plurality of solar collectors and configured to store at least a portion of the solar heat transfer fluid that has been heated by the plurality of solar collectors;
at least one heat transfer fluid line connecting the solar collectors, solar storage tank, and the at least one solar feedwater heater in a closed loop;
a plurality of solar heat transfer fluid control valves located along the at least one heat transfer fluid line, the solar heat transfer fluid control valves configured to control the amount of heated solar heat transfer fluid directed to the at least one solar feedwater heater, the solar heat transfer fluid control valves connected to an electronic control unit and configured to be activated by the electronic control unit;
a plurality of solar storage control valves located along the at least one solar heat transfer fluid line, the solar storage control valves configured to control the amount of heated solar heat transfer fluid being stored in the solar storage tank, the solar storage control valves connected with the electronic control unit and configured to be activated by the electronic control unit;
at least one turbine control valve located upstream of the high pressure steam turbine, the at least one turbine control valve configured to control the amount of steam entering the high pressure steam turbine, the at least one turbine control valve connected with the electronic control unit and configure to be activated by the electronic control unit;
a plurality of sensors configured to measure the temperature, flow rate, and pressure of the solar heat transfer fluid as it both enters and exits the at least one solar feedwater heater;
an operator interface comprising a display, the operator interface in communication with the electronic control unit;
wherein the electronic control unit is configured to receive operating parameter input from an operator including at least one of a capacity parameter and an efficiency parameter;
wherein the electronic control unit is configured to receive unit restraint operating parameters, a load forecast received from a grid regulating entity, a weather forecast, and a system cost;
wherein the electronic control unit is configured to receive temperature, flow, and pressure information from the sensors and calculate how much heat is being delivered to the at least one solar feedwater heater;
wherein the electronic control unit is configured to actuate the solar heat transfer fluid control valves, solar storage control valves, and at least one turbine control valve in response to the operator parameter input, unit restraint operating parameters, and information from the sensors;
wherein the electronic control unit is further configured to operate under in a first mode in which the electronic control unit:
opens at least one of the solar storage control valves and the solar heat transfer fluid control valves in order to direct heated heat transfer fluid to a first solar feedwater heater located upstream of a high pressure feedwater heater in the feedwater train;
calculates the amount of heat being delivered to the first solar feedwater heater based on measured temperature, flow rate, and pressure information from the sensors;
determines whether the first solar feedwater heater has reached a maximum solar heat input level; and
when the first solar feedwater heater has reached the maximum solar heat input level, opens a heat transfer fluid control valve in fluid communication with a second heat transfer fluid control valve located downstream of the high pressure feedwater.
wherein the electronic control unit is further configured to operate under a second mode of operation in which the electronic control unit:
opens at least one of the solar storage control valves and the solar heat transfer fluid control valves in order to direct heated heat transfer fluid to a first solar feedwater heater located downstream of a high pressure feedwater heater in the feedwater train;
calculates the amount of heat being delivered to the first solar feedwater heater based on measured temperature, flow rate, and pressure information from the sensors;
determines whether the first solar feedwater heater has reached a maximum solar heat input level;
when the first solar feedwater heater has reached the maximum solar heat input level, opens a heat transfer fluid control valve in fluid communication with a second heat transfer fluid control valve located upstream of the high pressure feedwater; and
Operates and adjusts flows, temperatures and valves of the unit host plant such that the heat transfer fluid inputted into the feedwater stream does not exceed unit limits and restraints and that the unit's safety and operational stability are not jeopardized.

2. A control method for controlling a Rankine cycle power generation system that integrates solar heating, comprising:
heating a heat transfer fluid with a solar collector;
directing the heated heat transfer fluid to a first solar feedwater heater located upstream of a high pressure feedwater heater in a feedwater train;
calculating the amount of heat being delivered to the first solar feedwater heater based on measured temperature, flow rate, and pressure information from sensors located in the system;
determining whether the first solar feedwater heater has reached a maximum solar heat input level; and
when the first solar feedwater heater has reached the maximum solar heat input level, opening a heat transfer fluid control valve in fluid communication with a second heat transfer fluid control valve located downstream of the high pressure feedwater heater.

3. The control method of claim 2, wherein the control method further comprises adjusting the at least one turbine control valve in order to control the amount of steam entering a low pressure steam turbine of the system.

4. The control method of claim 2, additionally comprising receiving operating parameter input from an operator including at least one of a capacity parameter and efficiency parameter with an electronic control unit.

5. The control method of claim 2, additionally comprising receiving unit restraint operating parameters comprising a load forecast received from a grid regulating entity, a weather forecast, and a system cost with an electronic control unit.

6. The control method of claim 2, additionally comprising actuating the solar heat transfer fluid control valves, and at least one turbine control valve in response to the operator parameter input, unit restraint operating parameters, and information from the sensors.

7. A control method for controlling a Rankine cycle power generation system that integrates solar heating, comprising:
heating a heat transfer fluid with a solar collector;
directing the heat transfer fluid heated by the solar collector to a first solar feedwater heater located downstream of a high pressure feedwater heater in a feedwater train;
calculating an amount of heat delivered to the first solar feedwater heater based on measured temperature, flow rate, and pressure information from sensors located in the system;
determining whether the first solar feedwater heater has reached a maximum solar heat input level; and
when the first solar feedwater heater has reached the maximum solar heat input level, opening a heat transfer fluid control valve in fluid communication with a second heat transfer fluid control valve located upstream of the high pressure feedwater.

8. The control method of claim 7, wherein the control method further comprises adjusting at least one turbine control valve in order to control an amount of steam entering a high pressure steam turbine of the Rankine cycle power generation system.

9. The control method of claim 7, wherein the solar heat transfer fluid control valves are opened and closed by a electronic control unit.

10. The control method of claim 9, wherein the electronic control unit is configured to receive operating parameter input from an operator including at least one of a capacity parameter and efficiency parameter.

11. The control method of claim 10, wherein the electronic control unit is configured to receive unit restraint operating parameters comprising a load forecast received from a grid regulating entity, a weather forecast, and a system cost.

12. The control method of claim 10, wherein the electronic control unit is configured to actuate the solar heat transfer fluid control valves, solar storage control valves, and at least one turbine control valve in response to the operator parameter input, unit restraint operating parameters, and information from the sensors.

13. A method of operating a fossil fuel Rankine cycle power generation system that integrates solar heating, comprising:
heating heat transfer fluid with solar collectors;
directing at least a portion of the heat transfer fluid to at least one solar feedwater heater in a feedwater train in the system;
measuring the temperature, flow rate, and pressure of solar heat transfer fluid through the use of sensors as the solar heat transfer fluid both enters and exits the at least one solar feedwater heater in a feedwater train, and calculating the amount of heat delivered to the at least one solar feedwater heater;
receiving operating parameter input from an operator including at least one of a capacity parameter and efficiency parameter, the operator input being entered into an operator interface in communication with a electronic control unit;
receiving unit restraint operating parameters comprising a load forecast received from a grid regulating entity, a weather forecast, and a system cost, the unit restraint operating parameters being received by the electronic control unit;
actuating a plurality of solar heat transfer fluid control valves, and at least one turbine control valve in response to the operator parameter input, unit restraint operating parameters, and information from the sensors, the plurality of solar heat transfer fluid control valves, and at least one turbine control valve configured to control the amount of heat being delivered to the at least one solar feedwater heater.

14. The method of claim 13, wherein the plurality of solar heat transfer fluid control valves are located along at least one heat transfer fluid line, the solar heat transfer fluid control valves configured to control the amount of heated solar heat transfer fluid being directed to the at least one solar feedwater heater, the solar heat transfer fluid control valves further configured to be in communication with the electronic control unit and to be activated by the electronic control unit in response to operator input.

15. The method of claim 13, wherein a plurality of solar storage control valves are located along at least one solar heat transfer fluid line, the solar storage control valves configured to control the amount of heated solar heat transfer fluid being stored in a solar storage tank, the solar storage control valves further configured to be in communication with the electronic control unit and to be activated by the electronic control unit in response to operator input.

16. The method of claim 13, wherein the at least one turbine control valve is located upstream of a high pressure steam turbine, the at least one turbine control valve configured to control the amount of steam entering the high pressure steam turbine, the at least one turbine control valve further configured to be in communication with the electronic control unit and to be activated by the electronic control unit in response to operator input.

17. The method of claim 15, wherein when the back pressure of a condenser operatively coupled to the low pressure steam turbine prevents any further increase in turbine capacity, the amount of fossil fuel required for the Rankine cycle is reduced.

18. The method of claim 13, wherein the at least one solar feedwater heater comprises two solar feedwater heaters, one located upstream of a high pressure heater in the feedwater train, and one located downstream of the high pressure heater.

19. The method of claim 18, further comprising directing at least a portion of the heated heat transfer fluid from the solar heat collectors to a storage tank, the storage tank in fluid communication with the at least one solar feedwater heater.

20. The method of claim 19, further comprising directing at least a portion of the heated heat transfer fluid from the storage tank to the at least one solar feedwater heater.

21. The method of claim 20, further comprising calculating the heat delivery to the at least one solar feedwater heater by using known physical properties of the heat transfer fluid.

22. The method of claim 20, wherein as the temperature of the feedwater is increased due to solar heating by the heated heat transfer fluid, the amount of steam sent from a steam turbine to the feedwater train through extraction lines automatically decreases.

23. The method of claim 20, wherein the heat transfer fluid is oil.

24. The method of claim 20, wherein the heat transfer fluid is single phase.

25. The method of claim 20, wherein the heat transfer fluid is water, and wherein the water is vaporized into steam by the solar heat collectors.

26. The method of claim 20, further comprising regulating the feedwater temperature such that a minimal amount of extraction steam flows in the system in order to provide continuous heating to an extraction line serving a feedwater heater displaced by the addition of solar heat.

27. A method for solar heat storage in a Rankine cycle power generation system that integrates solar heating, comprising:
heating heat transfer fluid through the use of solar collectors and directing at least a portion of the heat transfer fluid to a solar storage tank operatively connected to the plurality of solar collectors and configured to store at least a portion of the solar heat transfer fluid that has been heated;
calculating the amount of future heat delivery available from the solar heat collectors based on a weather forecast received by a electronic control unit of the system;
regulating a first solar storage control valve located between the solar heat collectors and the solar storage tank to control an amount of heated solar heat transfer fluid entering the storage tank from the solar heat collectors;
regulating a second solar storage control valve to control an amount of heated solar heat transfer fluid moving directly from the solar heat collectors to at least one solar feedwater heater in the system.

28. The method of claim 27, wherein the storage tank is an elongated length of piping located underground and installed horizontally relative to the ground in a circuitous pattern.

29. The method of claim 28, wherein the first and second solar storage control valves are located along at least one solar heat transfer fluid line, the solar storage control valves configured to control the amount of heated solar heat transfer fluid being stored in the solar storage tank, the solar storage control valves further configured to be in communication with the electronic control unit and to be activated by the electronic control unit in response to operator input.

30. A control system for a steam driven power plant, comprising:
at least one boiler configured to heat water into steam;
at least one turbine connected to the boiler so that steam from the boiler drives the turbine;
at least one solar collector configured to heat a heat transfer fluid with solar energy; and
an electronic control unit with a user interface system, the electronic control unit configured to direct heat transfer fluid into at least one heater configured to add heat to water fed to the boiler, the user interface system being configured to provide a user of the system with an option of operating the system in a capacity maximizing mode and an efficiency maximizing mode.

31. The control system according to claim 30, additionally comprising at least one valve configured to control a flow of the heat transfer fluid from the solar collector to the heater, the electronic control unit being configured to adjust the valve based on which of the modes are selected by a user.

32. A control system for use in a Rankine cycle power plant that integrates solar heating, comprising:
at least one boiler configured to heat water into steam;
at least one turbine connected to the boiler so that steam from the boiler drives the turbine;
at least one solar collector configured to heat a heat transfer fluid with solar energy, the heat transfer fluid configured to heat water fed to the boiler;
at least one turbine control valve located upstream of the turbine configured to control the amount of steam entering the high pressure steam turbine; and
a control unit configured to determine at least one parameter of the heat added to the water fed to the boiler, the control unit being further configured to regulate the at least one turbine control valve based on the at least one parameter.

33. The control system of claim 32 additionally comprising a user interface system for the control unit, the user interface system being configured to provide a user of the system with an option of operating the system in a capacity maximizing mode and an efficiency maximizing mode

34. The control system of claim 32, wherein the at least one operating parameter comprises a condensate/feedwater flow rate, an amount of turbine capacity resulting from the solar heat added to the water, a turbine output, and, when condenser back pressure precludes an increase in turbine output, a flow to the condenser.

35. The control system of claim 32, wherein the at least one turbine control valve is regulated such that the amount of solar heat inputted into the system can be used for a fossil fuel displacement.
